(19) United States
(12) Patent Application Publication
(10) Pub. No.: US 2019/0249631 A1
(43) Pub. Date: Aug. 15, 2019

(54) Fuel Injection Valve

(71) Applicant: Hitachi Automotive Systems, Ltd., Hitachinaka-shi, Ibaraki (JP)

(72) Inventors: Akiyasu MIYAMOTO, Hitachinaka-shi (JP); Kiyotaka OGURA, Hitachinaka-shi (JP); Atsushi HOHKITA, Hitachinaka-shi (JP); Yuto ISHIZUKA, Hitachinaka-shi (JP); Takao MIYAKE, Hitachinaka-shi (JP)

(21) Appl. No.: 16/316,922

(22) PCT Filed: Jul. 12, 2017
(86) PCT No.: PCT/JP2017/025355

§ 371 Date: Jan. 10, 2019

(30) Foreign Application Priority Data
Aug. 26, 2016 (JP) 2016-165281

(51) Int. Cl. F02M 51/06; F02M 61/20; F02M 61/10; B05B 1/30

(52) U.S. Cl. CPC F02M 51/0657; B05B 1/3053; F02M 61/10; F02M 61/20

(57) ABSTRACT

Provided is a fuel injection valve capable of stroking a valve body in large and small two stages and capable of precisely controlling an injection flow rate at the stroke. Therefore, the fuel injection valve of the present invention is provided with a valve body for opening or closing a flow path, a movable element for driving the valve body in a valve opening direction, and a magnetic core for attracting the movable element, in which the movable element is separately configured from the valve body, and is configured by a first movable element having a first facing surface facing the magnetic core and having the first facing surface attracted by the magnetic core, and a second movable element separately configured from the first movable element, having a second facing surface facing the magnetic core, and having the second facing surface attracted by the magnetic core.

### TECHNICAL FIELD

The present invention relates to a fuel injection valve used in an internal combustion engine.

### BACKGROUND ART

As a background art in the present technical field, there is a fuel injection valve described in PTL 1 (JP 2014-141924 A) below. PTL 1 discloses a configuration “including, to configure a fuel injection valve having a variable stroke mechanism, a valve body 106 slidably provided, a first movable element 107 cooperating with the valve body, an internally fixed iron core 100 provided at a position facing a second movable element 105, an external fixed iron core 113, and a coil 115, in which a lift amount of the second movable element is set to be larger than a lift amount of the first movable element, and a part of the second movable element protrudes into the first movable element, whereby large and small lifts are configured using a difference in magnetic attraction force generated between the first movable element 107 and the second movable element 105”.

### CITATION LIST

### Patent Literature

PTL 1: JP 2014-141924 A

### SUMMARY OF INVENTION

### Technical Problem

However, in the configuration disclosed in PTL 1, since a bound amount when the inner second movable element collides against the fixed iron core is large in a valve opening operation, there is a possibility of occurrence of variation in an injection flow rate. Further, the bound amount when the valve body collides with a valve seat is also large in a valve closing operation, and thus there is also a possibility of occurrence of variation in the injection flow rate.

Therefore, an object of the present invention is to provide a fuel injection valve capable of stroking a valve body in large and small two stages and capable of precisely controlling an injection flow rate at the strokes.

### Solution to Problem

To achieve the above object, a fuel injection valve of the present invention includes a valve body for opening or closing a flow path; a movable element for driving the valve body in a valve opening direction; and a magnetic core for attracting the movable element, in which the movable element is separately configured from the valve body, and is configured by a first movable element having a first facing surface facing the magnetic core and having the first facing surface attracted by the magnetic core, and a second movable element separately configured from the first movable element, having a second facing surface facing the magnetic core, and having the second facing surface attracted by the magnetic core.

### Advantageous Effects of Invention

According to the present invention, a fuel injection valve capable of stroking a valve body in large and small two stages and capable of precisely controlling an injection flow rate at the strokes. Other configurations, actions, and effects of the present invention will be described in detail in the following embodiments.

### BRIEF DESCRIPTION OF DRAWINGS

FIG. 1 is a cross-sectional view of a fuel injection valve according to an embodiment of the present invention.

FIG. 2 is a cross-sectional view of a valve body of a fuel injection valve according to an embodiment of the present invention.

FIG. 3 is a cross-sectional view of a first movable element of a fuel injection valve according to an embodiment of the present invention.

FIG. 4 is a cross-sectional view of a second movable element of a fuel injection valve according to an embodiment of the present invention.

FIG. 5 is an enlarged view of a vicinity of a movable element of a fuel injection valve according to an embodiment of the present invention, illustrating a state in which a coil 108 is not electrified.

FIG. 6 illustrates a state in which the coil 108 becomes in an electrification state from FIG. 5, a first movable element 201 and a second movable element 202 move in a valve opening direction, and a first facing surface 201a collides with a valve body engaging portion 113a (collision surface) of an engaging member 113.

FIG. 7 illustrates a state in which the second movable element 202 is further displaced from the state in FIG. 6 and comes in contact with a second facing surface 202a and a downstream-side end surface 107a of a magnetic core 107.

FIG. 8 illustrates a state in which the only the first movable element 201 is further displaced from the state in FIG. and the first facing surface 201a comes in contact with the downstream-side end surface 107a of the magnetic core 107.

FIGS. 9A and 9B are diagrams illustrating behaviors of a valve body, an inner diameter-side movable element, and an outer diameter-side movable element of a fuel injection valve according to a first embodiment of the present invention.

FIG. 10 is a diagram illustrating injection amount characteristics according to the first example of the present invention.

### DESCRIPTION OF EMBODIMENTS

Hereinafter, embodiments of the present invention will be described with reference to the drawings.

### First Embodiment

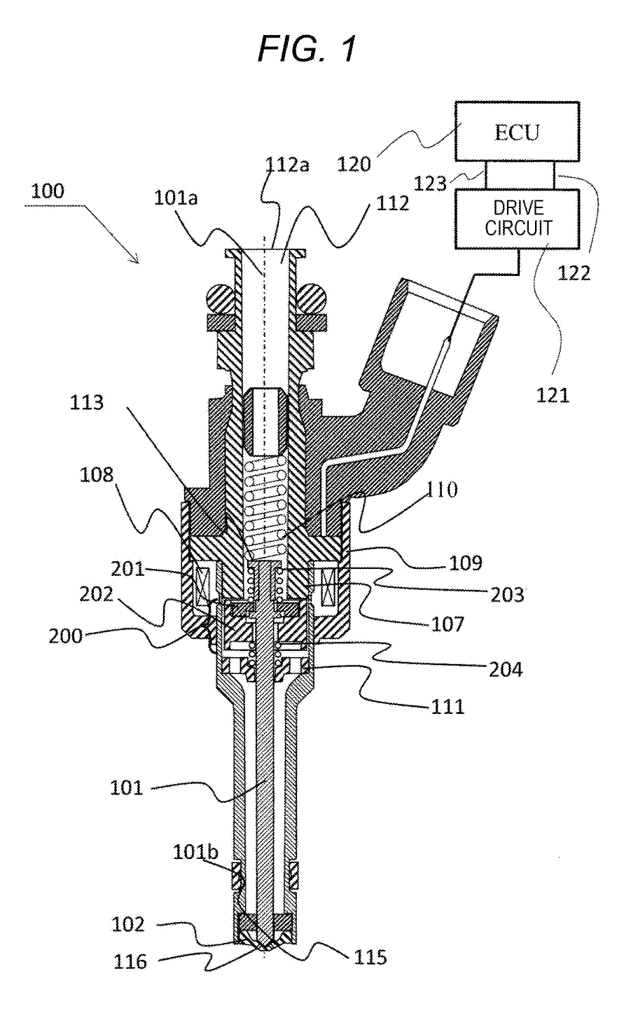

A first embodiment of the present invention will be described with reference to FIGS. 1 to 4. FIG. 1 illustrates a cross-sectional view of an electromagnetic fuel injection valve 100 (fuel injection device) of the present embodiment. FIG. 1 illustrates a longitudinal sectional view of the fuel injection valve 100 and a diagram illustrating an example of a configuration of a drive circuit (EDU) 121 and an engine control unit (ECU) 120 for driving the fuel injection valve 100.

Note that the fuel injection valve 100 illustrated in FIG. 1 is an electromagnetic fuel injection valve for cylinder direct injection gasoline engine, which directly injects a fuel into an engine cylinder. The present invention is also applicable to an electromagnetic fuel injection valve for port injection gasoline engine, which injects a fuel into an intake pipe for supplying air into an engine cylinder. Further, of course, the present invention is also applicable to a fuel injection valve driven by a piezo element or a magnetostrictive element.

The EDU 121 is a drive device that generates a drive voltage for the fuel injection valve 100. The ECU 120 takes in signals indicating a state of an engine from various sensors and calculates an appropriate drive pulse width and injection timing according to operation conditions of an internal combustion engine. The drive pulse output from the ECU 120 is input to the EDU 121 through a signal line 123. The EDU 121 applies a command voltage to a coil 108 according to the drive pulse or the injection timing instructed from the ECU 120 to supply a drive current.

The ECU 120 communicates with the EDU 121 through a communication line 122 and can switch the drive current generated by the EDU 121 according to a pressure of the fuel supplied to the fuel injection valve 100 and the operation conditions. The EDU 121 can change a control constant by communicating with the ECU 120, and a waveform of the drive current varies according to the control constant. Note that, in FIG. 1, an example in which the ECU 120 and the EDU 121 are separate bodies has been described as the drive device. However, the ECU 120 and the EDU 121 may be integrated.

First, an overall configuration of the fuel injection valve 100 and a flow of the fuel will be described. In the case of the electromagnetic fuel injection valve for cylinder direct injection gasoline engine, a metal pipe forming a fuel supply port 112 is attached to a common rail (not illustrated).

A high-pressure fuel is sent from a high-pressure fuel pump (not illustrated) to the common rail, and the high-pressure fuel having a set pressure (for example, 35 MPa) can be stored in the common rail. The high-pressure fuel in the common rail is supplied to an inside of the fuel injection valve 100 via a fuel inlet surface 112a of the fuel supply port 112. Note that, in the description of the present embodiment, the side of the fuel inlet surface 112a with respect to an axial direction (an up-down direction in FIG. 1) of the fuel injection valve 100 will be described as an upstream side, and the side of a seat member 102 will be described as a downstream side. Further, the direction from the fuel inlet surface 112a toward the seat member 102 is referred to as a downstream direction, and the opposite direction is referred to as an upstream direction.

The fuel injection valve 100 includes a valve body 101 that opens or closes a flow path and the cylindrical seat member 102 provided at a position facing a downstream-side distal end portion of the valve body 101. In the seat member 102, a seat portion 115 that seals the fuel as a valve body-side seat portion 101b of the valve body 101 is seated is formed and a fuel injection hole 116 through which the fuel is injected is formed on the downstream side of the seat portion 115.

The valve body 101 includes the valve body-side seat portion 101b that is pressed against the seat member 102 by a first spring 110 and comes into contact with the seat portion 115 to form a seal seat when the coil 108 is not electrified, and has a structure to seal the fuel.

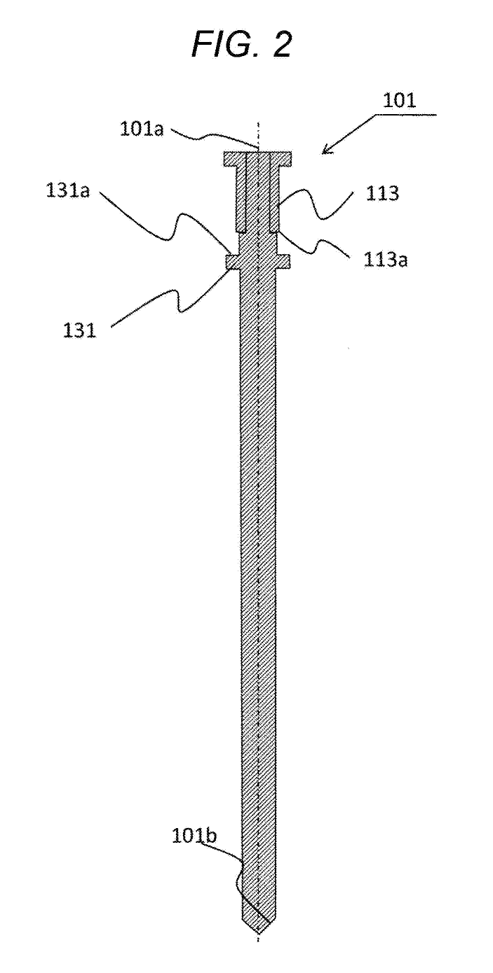

FIG. 2 illustrates a longitudinal sectional view of the valve body 101 of the present embodiment. An engaging member 113 (sleeve portion) is attached to the upstream-side distal end portion of the valve body 101. The engaging member 113 has a cylindrical portion attached to an outer diameter side of a small-diameter portion of the valve body and a protruding portion protruding to the outer diameter side at an upper end of the engaging member 113.

As illustrated in FIG. 1, the valve body 101 is biased to the downstream side by the first spring 110 via an upper surface portion of the protruding portion of the engaging member 113. Note that, since a biasing force of the first spring 110 is larger than a biasing force of a third spring 204, the valve body 101 is biased in the downstream direction in a non-electrification state of the coil 108, thereby to become in a valve closed state. Although details will be described below, a second spring 203 that biases a movable portion in the downstream direction is held by a lower surface portion of the protruding portion of the engaging member 113.

The fuel injection valve 100 includes a movable element group 200, a magnetic core 107, and the coil 108 located on the outer diameter side of the magnetic core, for forming a magnetic circuit and driving the valve body 101 by a magnetic attraction force. The movable element group 200 is separately and independently formed of the valve body 101 and is divided into a first movable element 201 and a second movable element 202.

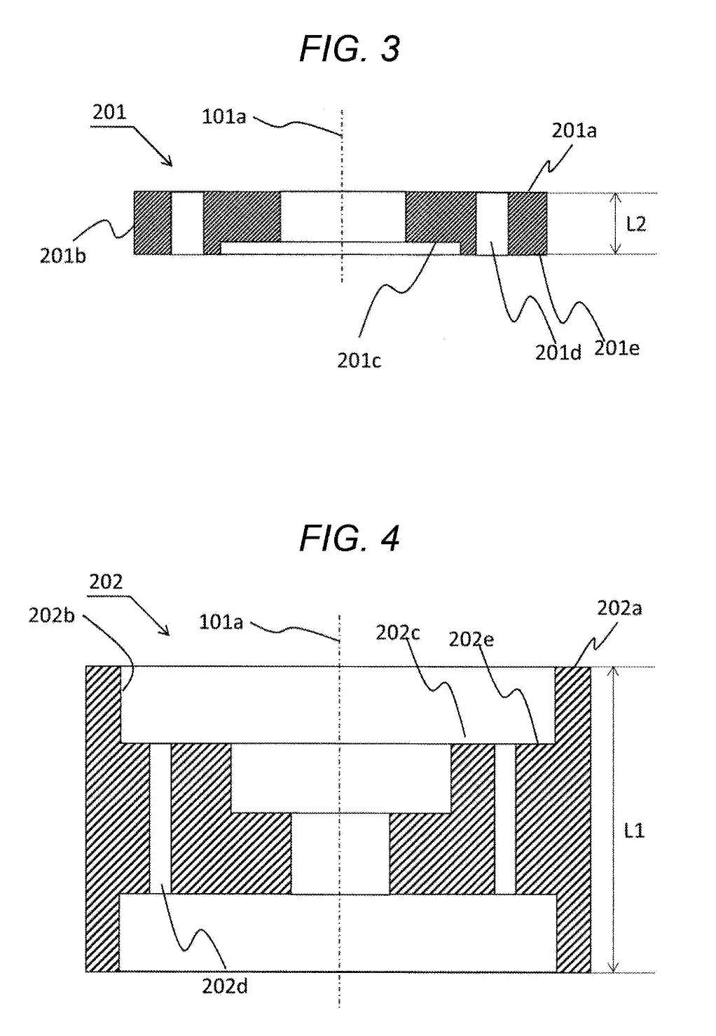

FIG. 3 is a longitudinal sectional view of the first movable element 201 of the present embodiment, and FIG. 4 is a longitudinal sectional view of the second movable element 202 of the present embodiment. The first movable element 201 has a first facing surface 201a facing the magnetic core 107, and the first facing surface 201a is attracted to the magnetic core 107. The second movable element 202 is separately configured from the first movable element 201, and has a second facing surface 202a facing to the magnetic core 107, and the second facing surface 202a is configured to be attracted to the magnetic core 107. With the configuration, the first movable element 201 and the second movable element 202 are attracted toward the magnetic core 107 by the magnetic attraction force, thereby to push up the valve body 101 in a valve opening direction.

The fuel injection valve 100 includes a nozzle holder 111 arranged on the outer diameter side of the valve body 101. The nozzle holder 111 includes a small-diameter portion on the downstream side and a large-diameter portion arranged on the upstream side with respect to the small-diameter portion. An upstream portion of the valve body 101 and the movable element group 200 are arranged on an inner diameter side in the large-diameter portion of the nozzle holder 111.

When a current is supplied from the EDU 121 that is the drive circuit to the coil 108, a magnetic flux is generated in the magnetic core 107, a yoke 109, the first movable element 201, and the second movable element 202 to form a magnetic circuit. As a result, a magnetic attraction force is generated between the magnetic core 107 and the first movable element 201 and between the magnetic core 107 and the second movable element 202.

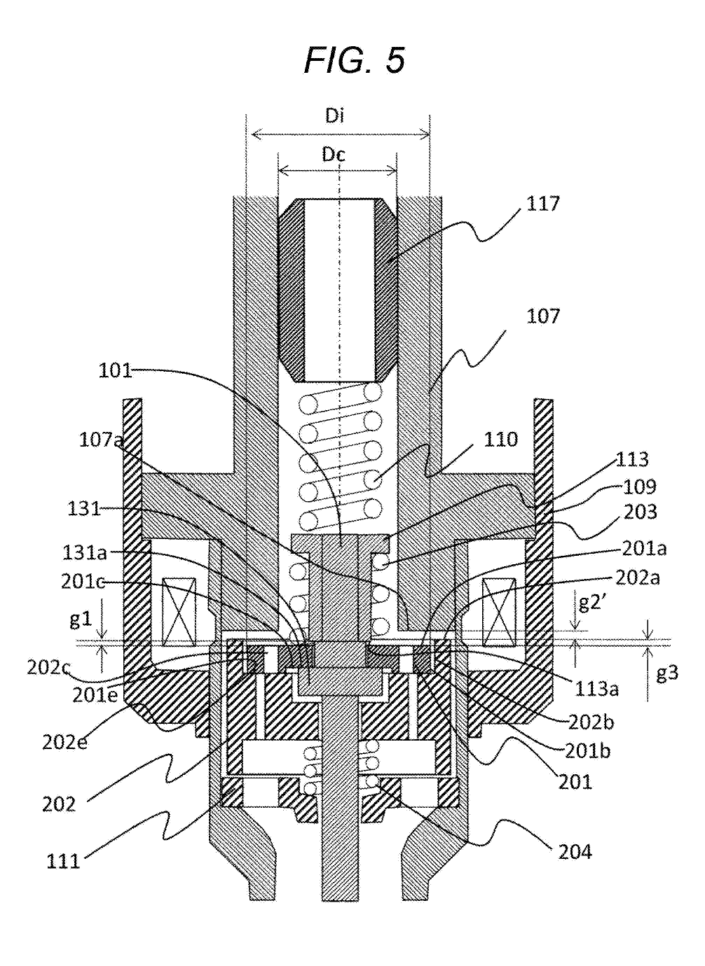

Although details will be described below with reference to FIGS. 5 to 8, the second movable element 202 is configured to move the valve body 101 to the upstream side in a case where the second movable element 202 moves toward the magnetic core 107 by the magnetic attraction force caused between the magnetic core 107 and the second movable element 202. Further, the first movable element 201 is configured to move the valve body 101 to the upstream side in a case where the first movable element 201 moves toward the magnetic core 107.

Further, in the present embodiment, as illustrated in FIGS. to 5, the second facing surface 202a of the second movable element 202 is arranged on the outer diameter side with respect to the first facing surface 201a of the first movable element 201. In other words, the first facing surface 201a of the first movable element 201 is configured to be arranged on the inner diameter side with respect to the second facing surface 202a of the second movable element 202. That is, an outer diameter of the first facing surface 201a of the first movable element 201 is smaller than an inner diameter of the second facing surface 202a of the second movable element 202, and the entire first facing surface 201a of the first movable element 201 is arranged on the inner diameter side of the second facing surface 202a of the second movable element 202.

An outer peripheral portion 201b of the first movable element 201 is configured to face an inner peripheral portion 202b of the second movable element 202 in a direction orthogonal to a valve body axial direction 101a. That is, the outer peripheral portion 201b of the first movable element 201 is configured to face the inner peripheral portion 202b of the second movable element 202 in a horizontal direction (a left-right direction in FIG. 5). Note that the first movable element 201 and the second movable element 202 operate independently of each other, the outer peripheral portion 201b of the first movable element 201 and the inner peripheral portion 202b of the second movable element 202 are arranged with a gap in the horizontal direction.

Then, in the direction of the valve body axis 101a (in the up-down direction in FIG. 5), a downstream-side end surface 201e of the first movable element 201 is configured to face an upstream-side end surface 202e of the second movable element 202. Note that, in the valve closed state where no movable elements operate, as illustrated in FIG. 5, the downstream-side end surface 201e of the first movable element 201 and the upstream-side end surface 202e of the second movable element 202 are configured to be in contact with each other.

A recessed portion 202c recessed toward the downstream side is formed in the inner diameter side of the second movable element 202, and the first movable element 201 is contained inside the recessed portion 202c. That is, the recessed portion 202c of the second movable element 202 is formed to be recessed from the second facing surface 202a toward the downstream side on the inner diameter side with respect to the second facing surface 202a formed on the outer diameter side. Then, the first movable element 201 is arranged inside the recessed portion 202c. Specifically, in the valve closed state where no movable elements operate, as illustrated in FIG. 5, the first facing surface 201a of the first movable element 201 is located on the downstream side with respect to the second facing surface 202a of the second movable element 202. Therefore, the entire first movable element 201 is configured to be located inside the recessed portion 202c of the second movable element 202.

As illustrated in FIGS. 3 and 4, the length relationship between the first movable element 201 and the second movable element 202 in the direction of the valve body axis 101a is configured such that an axial maximum length L2 of the second movable element 202 becomes longer than an axial maximum length L1 of the first movable element 201.

Here, as illustrated in FIGS. 2 and 5, the valve body 101 has a protruding portion 131 that protrudes to the outer diameter side on the upstream side. The protruding portion 131 may be referred to as a stepped portion or may be referred to as a flange portion. A downstream-side support surface 201c of the first movable element 201 is supported facing an upstream-side end surface 131a of the protruding portion 131. In the valve closed state where no movable elements operate, as illustrated in FIG. 5, the upstream-side end surface 131a of the protruding portion 131 of the valve body 101 is configured to be in contact with the downstream-side support surface 201c of the first movable element 201.

Note that, in the present embodiment, the downstream-side support surface 201c of the first movable element 201 is formed on the upstream side with respect to the downstream-side end surface 201e of the first movable element 201. That is, in the first movable element 201, the downstream-side support surface 201c is formed to be recessed to the upstream side from the downstream-side end surface 201e.

As illustrated in FIGS. 2 and 5, the valve body 101 has a valve body engaging portion 113a to be engaged with the first movable element 201 on the upstream side. Specifically, a lower end portion of the cylindrical portion of the engaging member 113 attached to the valve body 101 constitutes the valve body engaging portion 113a. Note that, in the present embodiment, the valve body 101 and the engaging member 113 are formed as separate bodies, but the valve body 101 and the engaging member 113 may be integrally formed. In the case where the first movable element 201 moves to the upstream side, the first movable element 201 is engaged with the valve body engaging portion 113a to move the valve body 101 to the upstream side (in the valve opening direction). More specifically, in the case where the first movable element 201 moves to the upstream side, the upstream-side end surface 201a of the first movable element 201 and a lower end of the valve body engaging portion 113a are engaged with each other, and the valve body engaging portion 113a is pushed up to the upstream side, whereby the valve body 101 is moved to the upstream side (in the valve opening direction).

Here, the first movable element 201 has a first engaging portion (downstream-side end surface 201e) to be engaged with the second movable element 202. In the case where the second movable element 202 moves to the upstream side, the second movable element 202 and the first movable element 201 are engaged with each other by the first engaging portion (downstream-side end surface 201e), and thus the first movable element 201 is engaged with the valve body engaging portion 113a, whereby the valve body 101 is moved to the upstream side (in the valve opening direction).

With these configurations, the magnetic attraction force of the second movable element 202 is configured to drive the valve body 101 via the first movable element 201, and the magnetic attraction force of the first movable element 201 is configured to drive the valve body 101 via the valve body engaging portion 113a.

The first movable element 201 and the second movable element 202 have a first fuel passage hole 201d and a second fuel passage hole 202d to reduce a fluid force generated when moving. Areas of hole portions of the first fuel passage hole 201d and the second fuel passage hole 202d in the vertical direction of the valve body axis 101a are sufficient areas to reduce the fluid force due to the excluded volume when the outer diameter-side movable element 201 and the inner diameter-side movable element 202 operate.

A horizontal area of the first fuel passage hole 201d is favorably larger than a horizontal area of the second fuel passage hole 202d. Further, although not illustrated, a plurality of the first fuel passage holes 201d and the second fuel passage holes 202d is desirably formed to secure the sufficient areas.

The second spring 203 is provided between the first movable element 201 and the valve body 101. The second spring 203 exerts a biasing force in a direction to separate the first movable element 201 from the valve body 101.

The third spring 204 is provided between the second movable element 202 and a spring holding member 117. The third spring 204 exerts a biasing force in a direction to separate the second movable element 202 from the spring holding member 117.

At this time, an absolute value of a biasing force Fm by the second spring 203 is set to be larger than an absolute value of a biasing force Fz by the third spring 204. Further, an outer diameter Di of the outer peripheral portion 201b in the upstream-side end surface 201a of the first movable element 201 is configured to be larger than an inner diameter Dc of an inner peripheral portion in a downstream-side end surface 107a of the magnetic core 107. Therefore, when the coil 108 is electrified, a magnetic flux is generated in a gap between the second movable element 202 having an attractive surface formed on the outer diameter side and the magnetic core 107 and in a gap between the first movable element 201 having an attractive surface on the inner diameter side and the magnetic core 107 to cause a magnetic attraction force.

Next, relationships between gaps provided between the valve body 101, and the first movable element 201 and the second movable element 202, and operations of members when the drive current is supplied to the coil 108 will be described with reference to FIGS. 5 to 8.

In the state where the coil 108 is not electrified as illustrated in FIG. 5, the engaging member 113 is biased by the first spring 110, whereby the valve body-side seat portion 101b of the valve body 101 comes into contact with the seat portion 115 of the seat member 102 to become the valve closed state. In this case, the first movable element 201 is biased to the downstream side by the second spring 203, thereby to bias the upstream-side end surface 131a (contact surface) provided on the upstream side of the protruding portion 131 (stepped portion) and stand still in this state. Note that the spring holding member 117 is held at an upper portion of the magnetic core 107, and the first spring 110 is supported at a downstream-side end surface of the spring holding member 117.

Further, the second movable element 202 is biased to the upstream side (in the valve opening direction) by the third spring 204, and the upstream-side end surface 202e of the second movable element 202 is engaged with the first engaging portion (downstream-side end surface 201e) of the first movable element 201, whereby the second movable element 202 also maintains a stationary state. In the stationary closed valve state, a gap g1 is provided between the first facing surface 201a of the first movable element 201 and the valve body engaging portion 113a (sleeve portion).

When the drive current is supplied to the coil 108 from the state in FIG. 5, a magnetic flux is generated in the magnetic core 107, the yoke 109, the first movable element 201, and the second movable element 202 to form a magnetic circuit. As a result, a magnetic attraction force is generated between the magnetic core 107 and the first movable element 201 and between the magnetic core 107 and the second movable element 202.

As shown in the expression (1), when a sum of a magnetic attraction force Fi acting between the first movable element 201 and the magnetic core 107 and a magnetic attraction force Fo acting between the second movable element 202 and the magnetic core 107 becomes larger than a difference between a biasing force Fm by the intermediate spring 203 and a biasing force Fz by the zero spring 204, the first movable element 201 and the second movable element 202 are attracted toward the magnetic core 107 and start movement.

Fo+Fi>Fm−Fz Expression (1)

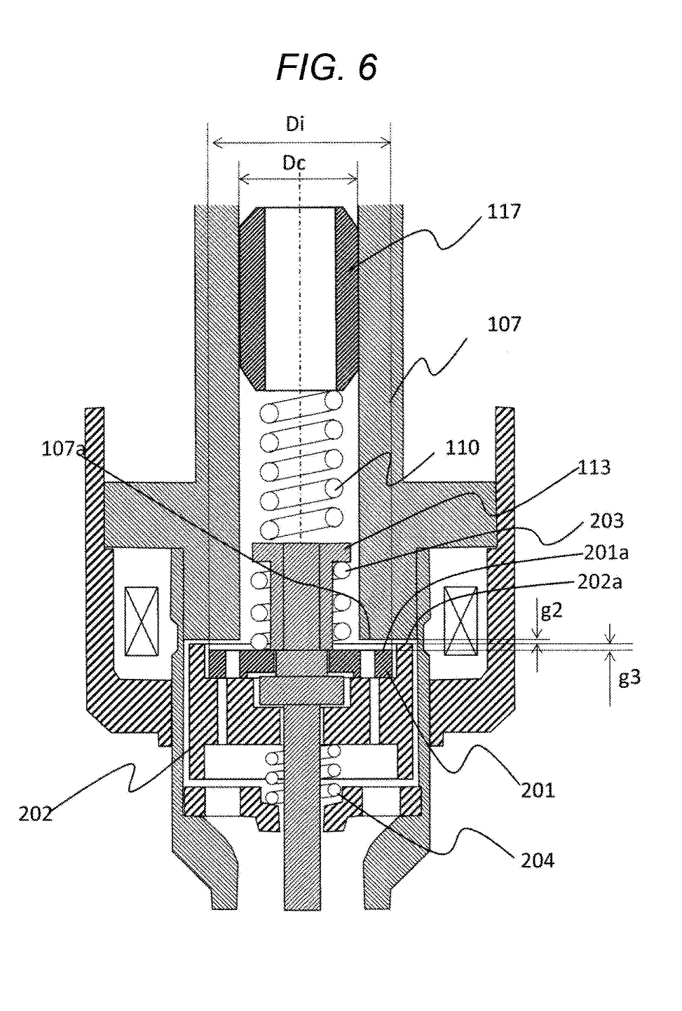

When the first movable element 201 is displaced by the gap g1 provided in advance between the valve body engaging portion 113a and the first movable element 201 on the inner diameter side, a gap provided between the downstream-side end surface 107a of the magnetic core 107 and the second facing surface 202a of the second movable element 202, as illustrated in FIG. 6, is decreased from g2′ in FIGS. 5 to g2 in FIG. 6. Note that a relationship of g2′−g2=g1 is established. Further, the gap g2 can be said to be a clearance between the second facing surface 202a of the second movable element 202 and the downstream-side end surface 107a of the magnetic core 107 in a state where the first facing surface 201a of the first movable element 201 collides with the lower end of the valve body engaging portion 113a of the engaging member 113. In FIG. 6, the first facing surface 201a of the first movable element 201 on the inner diameter side collides with the valve body engaging portion 113a (collision surface) of the engaging member 113 and the second facing surface 202a.

This gap g1 is called preliminary stroke. Kinetic energy stored in the first movable element 201 and the second movable element 202 with the gap g1 is used for a valve opening operation of the valve body 101. Therefore, the responsiveness of the valve opening operation is improved by the use of the kinetic energy, and the valve can be opened under a high fuel pressure. To secure the preliminary stroke, the gap g2′>the gap g1 is required in the valve closed state in FIG. 5.

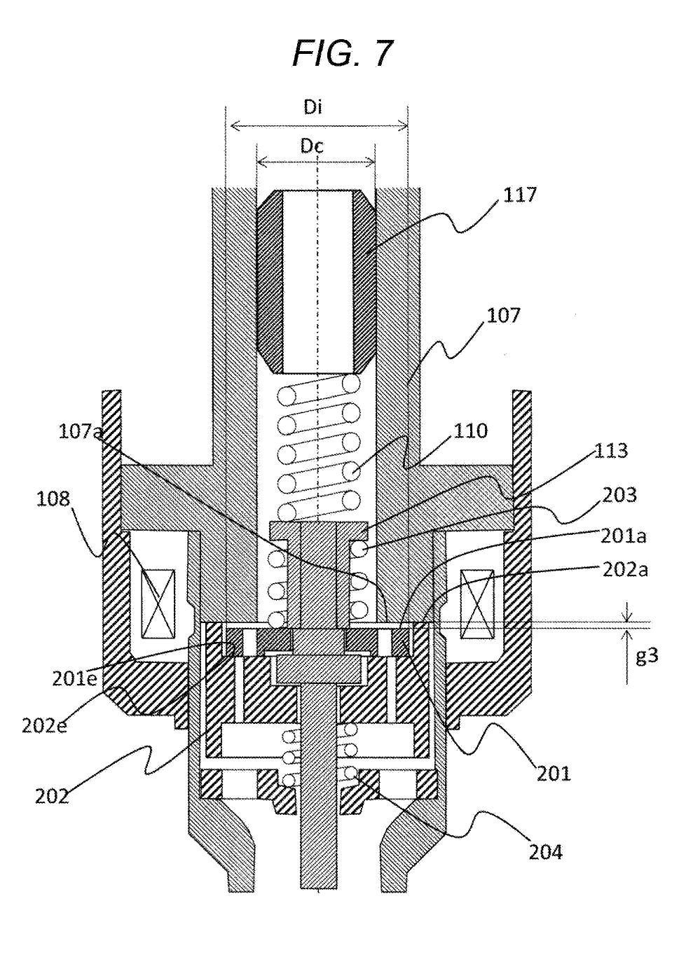

When the electrification to the coil 108 is continued and the second movable element 202 further displaces from the state in FIG. 6 by the gap g2 provided in advance between the second movable element 202 on the outer diameter side and the downstream-side end surface 107a of the magnetic core 107, the state illustrated in FIG. 7 is obtained. In FIG. 7, the movement of the second movable element 202 on the outer diameter side is restricted by the downstream-side end surface 107a of the magnetic core 107.

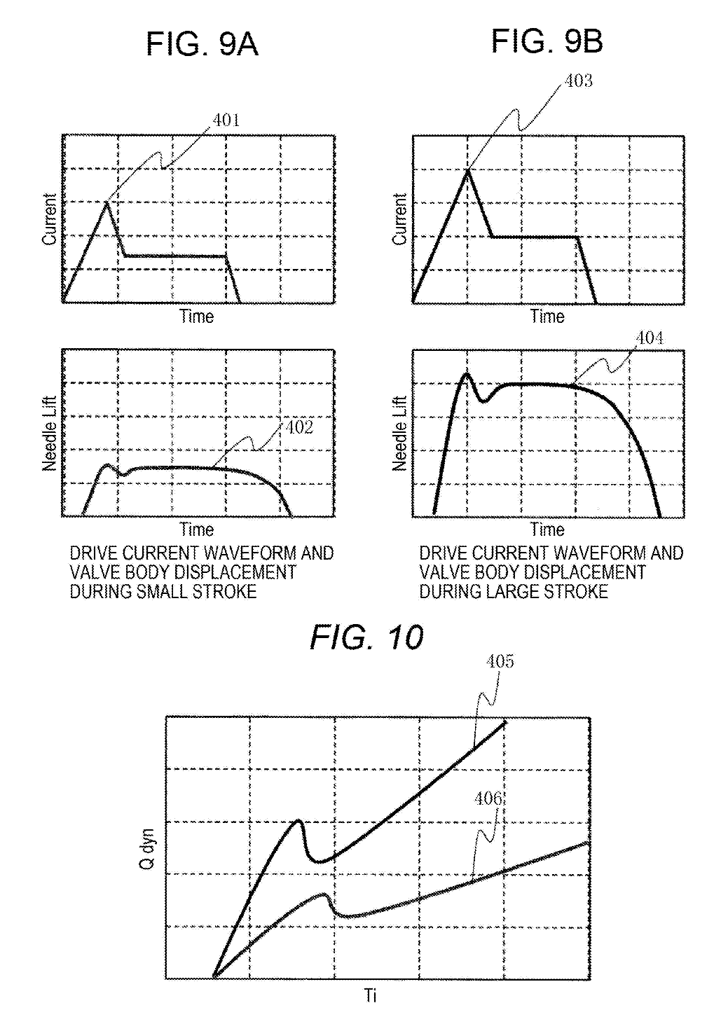

FIG. 9 illustrates a drive current waveform and valve body displacement at (a) small stroke, and illustrates a drive current waveform and valve body displacement (b) at large stroke, in the present embodiment. A case where a peak current 401 of the drive current to be supplied to the coil 108 is made smaller than a set value, as illustrated in FIG. 9(a), will be described.

In this case, a force relationship in the expression (2) below, that is, a condition that the sum of the magnetic attraction force Fi of the first movable element 201 and the magnetic attraction force Fo of the second movable element 202 becomes larger than a sum of a differential pressure Fp by the fluid acting on the valve body 101 and a biasing force Fs by the first spring 110, is satisfied. Further, a force relationship in the expression (3) below, that is, a condition that the magnetic attraction force Fi of the first movable element 201 becomes smaller than the sum of the differential pressure Fp by the fluid acting on the valve body 101 and the biasing force Fs by the first spring 110

Fs+Fp<Fi+Fo Expression (2)

Fs+Fp>Fi Expression (3)

Therefore, in the case of the current waveform in FIG. 9(a), the above expressions (2) and (3) are satisfied, so the gap (g′2 in FIG. 5) between the second facing surface 202a of the second movable element 202 and the downstream-side end surface 107a of the magnetic core 107 is gone, as illustrated in FIG. 7, and only a gap g3 between the first facing surface 201a of the first movable element 201 and the downstream-side end surface 107a of the magnetic core 107 remains. That is, the valve body 101 is displaced by the magnetic attraction force Fo of the second movable element 202 according to the expression (2), whereas the valve body 101 cannot be displaced only by the magnetic attraction force Fi of the first movable element 201 according to the expression (3).

From the state in FIG. 7 (small stroke state), the drive current to the coil 108 is cut off from the peak current or is lowered to an intermediate current lower than the peak current, as illustrated in FIG. 9(a), whereby the magnetic flux caused between the magnetic core 107, and the first movable element 201 on the inner diameter side and the second movable element 202 on the outer diameter side disappears or becomes small.

As a result, the magnetic flux becomes small and thus the magnetic attraction force between the magnetic core 107 and the first movable element 201 and the second movable element 202 becomes smaller than the biasing force of the first spring 110 and the fluid force acting on the valve body 101, the first movable element 201 on the inner diameter side and the second movable element 202 on the outer diameter side start displacement to the downstream side. Then, with the movement, the valve body 101 starts a valve closing operation, and thereafter, the valve body-side seat portion 101b of the valve body 101 collides with the seat portion 115 of the seat member 102, and the valve is closed.

Therefore, in the case of the current waveform in FIG. 9(a), the valve body 101 is displaced by a valve body displacement 402 provided between the second facing surface 202a of the second movable element 202 and the downstream-side end surface 107a of the magnetic core 107, as illustrated in the lower diagram in FIG. 9(a). Note that the valve body displacement 402 corresponds to the gap g2 illustrated in FIG. 6.

The movement in the axial direction of the second movable element 202 is restricted by a collision with the downstream-side end surface 107a of the magnetic core 107 or with a member different from the magnetic core 107. As the restriction, a displacement amount of the valve body 101 becomes stable, and therefore a stable injection amount can be supplied. On the other hand, a case in which a peak current 403 of the drive current to be supplied to the coil 108 is made larger than the preset set value, as illustrated in FIG. 9(b), will be described. That is, the peak current can be made larger in the case where the valve body 101 is driven at the large stroke than the peak current 401 at the small stroke in FIG. 9(a). In this case, the magnetic attraction force Fi of the first movable element 201 on the inner diameter side is made larger than the sum of the differential pressure Fp by the fluid acting on the valve body 101 and the biasing force Fs by the first spring 110, as illustrated in the expression (4).

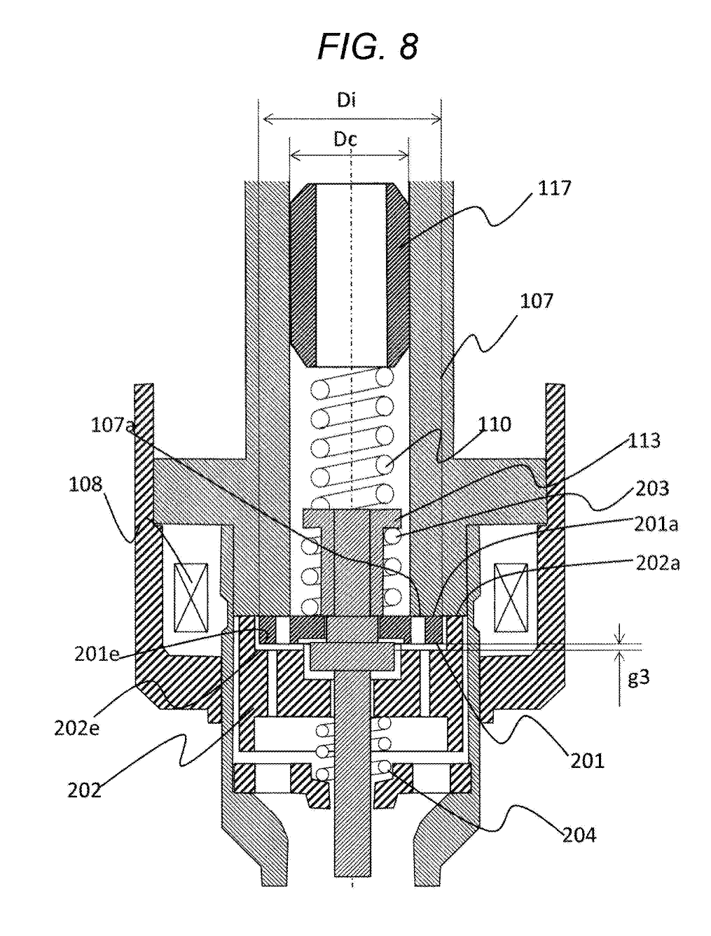

As a result, as illustrated in FIG. 8, the first movable element 201 on the inner diameter side is displaced in the upstream direction by a gap g3 provided between the downstream-side end surface 107a of the magnetic core 107 and the first facing surface 201a of the first movable element 201 in FIG. 7. That is, the gap g3 can be said to be a clearance between the first facing surface 201a of the first movable element 201 and the downstream-side end surface 107a of the magnetic core 107 in the state where the second facing surface 202a of the second movable element 202 collides with the downstream-side end surface 107a of the magnetic core 107. As a result, the first movable element 201 further pulls up the valve body 101 from the state in FIG. 7 by the gap g3. Therefore, the valve body 101 is displaced by a sum of the gap g2 and the gap g3 in total. This displacement is called large stroke.

Note that the displacement of the first movable element 201 is restricted by a collision with the magnetic core 107 or with a fixing member different from the magnetic core 107. Therefore, the behavior of the valve body 101 is stabilized, and thus a stable injection amount can be supplied.

Fs+Fp>Fi Expression (4)

The drive current to the coil 108 is cut off from the peak current 403 or is lowered to the intermediate current smaller than the peak current 403, from the state in FIG. 8 at the large stroke. As a result, the magnetic flux generated between the first movable element 201 on the inner diameter side and the magnetic core 107 disappears or decreases. Then, when the magnetic attraction force between the first movable element 201 on the inner diameter side and the magnetic core 107 becomes smaller than the biasing force of the first spring 110 and the fluid force acting on the valve body 101, the first movable element 201 is displaced to the downstream side.

The first movable element 201 moves on to the valve closing operation earlier than the second movable element 202 due to the fluid force and the biasing force by the first spring 110, in addition to the magnetic flux starting to disappear from the first movable element 201 on the inner diameter side. As a result, the first movable element 201 on the inner diameter side is displaced to the downstream side by the gap g3 between the downstream-side end surface 201e and the upstream-side end surface 202e of the second movable element 202, and collides with the upstream-side end surface 202e of the second movable element 202. The second movable element 202 is also displaced to the downstream side by the collision with the first movable element 201. The valve body 101 starts the valve closing operation with the movement, and thereafter, the valve body-side seat portion 101b collides with the seat portion 115 of the seat member 102, and the valve is closed. As a result, the valve body 101 has the large stroke, and the displacement amount becomes the amount as indicated by 404, as illustrated in FIG. 9(b). The displacement amount 404 corresponds to the sum of the gap g2 and the gap g3.

In the present embodiment, the displacement of the valve body 101 is made switchable between the small stroke in FIG. 9(a) and the large stroke in FIG. 9(b) by the drive current to be supplied to the coil 108 of the fuel injection valve 100. Then, in the valve closed state, a first clearance (the gap g2′+the gap g3 or the gap g2+the gap g3) between the first facing surface 201a of the first movable element 201 and the magnetic core 107 is configured to be larger than a second clearance (the gap g2′ or the gap g2) between the second facing surface 202a of the second movable element 202 and the magnetic core 107.

Here, the gap g1 is defined as a clearance between the first facing surface 201a of the first movable element 201 and the valve body engaging portion 113a of the valve body 101 in the valve closed state. Further, the gap g2 is defined as the clearance between the second facing surface 202a of the second movable element 202 and the downstream-side end surface 107a of the magnetic core 107 in a state where the first facing surface 201a of the first movable element 201 collides with the lower end of the valve body engaging portion 113a of the engaging member 113. Further, the gap g3 is defined as the clearance between the first facing surface 201a of the first movable element 201 and the downstream-side end surface 107a of the magnetic core 107 in the state where the second facing surface 202a of the second movable element 202 collides with the downstream-side end surface 107a of the magnetic core 107.

Here, it is desirable to satisfy the gap g3>the gap g2 in the case where the displacement of the valve body 101 is switched between the small stroke in FIG. 9(a) and the large stroke in FIG. 9(b) by the drive current, as described above. The gap g2 (stroke) can be set with high precision because stroke adjustment is performed when the fuel injection valve 100 is assembled. In the present embodiment, the stroke amount of the gap g2 is adjusted by adjusting a press-fitting amount when the seat member 102, against which the valve body 101 is pressed, is press-fitted into the nozzle holder 111. Note that, in the present embodiment, the press-fitting amount between the seat member 102 and the nozzle holder 111 is adjusted. However, the present invention is not limited to the case.

Meanwhile, the gap g3 is the clearance between the first facing surface 201a of the first movable element 201 and the downstream-side end surface 107a of the magnetic core 107 in the state where the second facing surface 202a of the second movable element 202 collides with the downstream-side end surface 107a of the magnetic core 107, and thus the stroke amount cannot be adjusted like the gap g2. Therefore, the gap g2 for determining the large stroke amount is desirably set to a large amount in consideration of component tolerances. In the present embodiment, the gap g2 and the gap g1 for determining the preliminary stroke amount are substantially the same or the gap g3>the gap g1 is set.

The movable element group 200 is divided into the first movable element 201 and the second movable element 202, and the drive current to be supplied to the coil 108 is changed in this manner, whereby the displacement of the valve body 101 can be made variable. FIG. 10 illustrates injection amount characteristics (a relationship between an injection command period and the injection amount) at the strokes. The current waveform is changed according to a necessary flow rate, as illustrated in FIG. 9, whereby an injection amount characteristic 405 at the large stroke and an injection amount characteristic 406 at the small stroke are obtained. Therefore, the injection amount characteristic 405 at the large stroke is used in the case where a large flow rate is required, whereas the injection amount characteristic 406 at the small stroke is used in the case where a small flow rate is required, whereby an optimum fuel injection amount necessary for combustion of the internal combustion engine can be supplied.

In the present embodiment, an intake air amount, a rotational speed of the internal combustion engine, a fuel injection pressure, and an accelerator opening are sensed, and the current waveform of the drive current to be supplied to the coil 108 of the fuel injection valve is switched on the basis of thresholds for the information. However, the present invention is not limited to thereto, and similar effects can be obtained by switching the current waveform as needed, using another information.

As described above, according to the present embodiment, the plurality of strokes is configured to widen the control range of the fuel injection amount. In addition, the fuel injection valve that enables stroke of the valve body in two stages and can control of the injection flow rate at the stroke with high precision, with the gap provided between the valve body or a component engaged with the valve body and the movable element in the valve closed state, can be provided. Therefore, the kinetic energy of the movable element can be utilized for the valve opening operation, and optimal fuel injection can be realized in a wide operation range of the internal combustion engine.

### REFERENCE SIGNS LIST

101 valve body
101b valve body-side seat portion
102 seat member
107 magnetic core
108 coil
109 yoke
110 first spring
203 second spring
204 third spring
112 fuel supply port
113 sleeve
201 first movable element
202 second movable element

1. A fuel injection valve comprising:
a valve body configured to open or close a flow path;
a movable element configured to drive the valve body in a valve opening direction; and
a magnetic core configured to attract the movable element, wherein
the movable element is separately configured from the valve body, and is configured by
a first movable element having a first facing surface facing the magnetic core and having the first facing surface attracted by the magnetic core, and
a second movable element separately configured from the first movable element, having a second facing surface facing the magnetic core, and having the second facing surface attracted by the magnetic core.

2. The fuel injection valve according to claim 1, wherein
the second movable element moves the valve body to an upstream side in a case where the second movable element moves toward the magnetic core, and the first movable element moves the valve body to the upstream side in a case where the first movable element moves toward the magnetic core.

3. The fuel injection valve according to claim 1, wherein
the second facing surface of the second movable element is arranged on an outer diameter side with respect to the first facing surface of the first movable element.

4. The fuel injection valve according to claim 1, further comprising:
a coil configured to cause a magnetic attraction force between the magnetic core and the movable element when a drive current flows, wherein
the second facing surface of the second movable element is attracted to come into contact with the magnetic core in a case where a set first drive current flows in the coil.

5. The fuel injection valve according to claim 1, further comprising:
a coil configured to cause a magnetic attraction force between the magnetic core and the movable element when a drive current flows, wherein
only the second facing surface of the second movable element is attracted to come into contact with the magnetic core in a case where a set first drive current flows in the coil.

6. The fuel injection valve according to claim 1, further comprising:
a coil configured to cause a magnetic attraction force between the magnetic core and the movable element when a drive current flows, wherein
the second facing surface of the second movable element is attracted to come into contact in a case where a set first drive current flows in the coil, and
the first facing surface of the first movable element and the second facing surface of the second movable element are attracted to come into contact in a case where a second drive current larger than the first drive current flows in the coil.

7. The fuel injection valve according to claim 1, further comprising:
a coil configured to cause a magnetic attraction force between the magnetic core and the movable element when a drive current flows, wherein
only the second facing surface of the second movable element is attracted to come into contact with the magnetic core in a case where a set first drive current flows in the coil, and
the first facing surface of the first movable element and the second facing surface of the second movable element are attracted to come into contact with the magnetic core in a case where a second drive current larger than the first drive current flows in the coil.

8. The fuel injection valve according to claim 1, wherein
a first clearance between the first facing surface of the first movable element and the magnetic core is configured to be larger than a second clearance between the second facing surface of the second movable element and the magnetic core in a valve closed state.

9. The fuel injection valve according to claim 1, wherein
an outer peripheral portion of the first movable element is configured to face an inner peripheral portion of the second movable element in a direction orthogonal to a valve body axial direction, and
a downstream-side end surface of the first movable element is configured to face an upstream-side end surface of the second movable element in the valve body axial direction.

10. The fuel injection valve according to claim 1, wherein
a recessed portion recessed toward a downstream side is formed on an inner diameter side in the second movable element, and the first movable element is arranged inside the recessed portion.

11. The fuel injection valve according to claim 1, wherein
an axial maximum length of the second movable element is configured to be longer than an axial maximum length of the first movable element.

12. The fuel injection valve according to claim 1, wherein
the valve body has a protruding portion protruding toward an outer diameter side on an upstream side, and
a downstream-side end surface of the first movable element faces and is supported by an upstream-side end surface of the protruding portion.

13. The fuel injection valve according to claim 1, wherein
the valve body has a valve body engaging portion engaged with the first movable element on an upstream side, and
the first movable element is engaged with the valve body engaging portion to move the valve body to the upstream side in a case where the first movable element moves to the upstream side.

14. The fuel injection valve according to claim 1, wherein
the valve body has a valve body engaging portion engaged with the first movable element on an upstream side, and
the first movable element has a first engaging portion engaged with the second movable element, and when the second movable element and the first movable element are engaged with each other by the first engaging portion in a case where the second movable element moves to the upstream side, the first movable element and the valve body engaging portion are engaged with each other, to move the valve body to the upstream side.

15. The fuel injection valve according to claim 1, further comprising:
a first spring configured to bias the valve body to a downstream side.

16. The fuel injection valve according to claim 1, further comprising:
a second spring attached to the valve body, and for biasing the first movable element to a downstream side.

17. The fuel injection valve according to claim 15, further comprising:
a third spring configured to bias the second movable element to an upstream side.

18. The fuel injection valve according to claim 16, wherein
a biasing force of the first spring is set to be larger than a biasing force of the second spring.

19. The fuel injection valve according to claim 17, wherein
a biasing force of the first spring is set to be larger than a biasing force of the second spring, and
the biasing force of the second spring is set to be larger than a biasing force of the third spring.

20. The fuel injection valve according to claim 1, wherein
an outer diameter of an outer peripheral portion in an upstream-side end surface of the first movable element is configured to be larger than an inner diameter of an inner peripheral portion on a downstream-side end surface of the magnetic core.
